(19) United States
(12) Patent Application Publication
(10) Pub. No.: US 2018/0207456 A1
(43) Pub. Date: Jul. 26, 2018

(54) Fluid supply conduit

(71) Applicant: Lihai Katz, Haifa (IL)

(72) Inventor: Lihai Katz, Haifa (IL)

(21) Appl. No.: 15/416,033

(22) Filed: Jan. 26, 2017

(51) Int. Cl. A62C 3/02; B05B 9/00

(52) U.S. Cl. CPC A62C 3/0242; A62C 99/0072; B05B 9/007

(57) ABSTRACT

Methods and systems for fluid supply. In one example, a system includes a conduit for supplying pressurized fluid therethrough and having a proximal end configured for being connected to a fluid source and a distal end with a supply outlet for dispensing said fluid in a first direction. The conduit further includes at least one jet outlet configured to provide a jet fluid flow in a second direction other than the first direction, exerting thereby thrust on at least a portion of said conduit in a third direction. And a tilting mechanism configured to tilt said at least one jet outlet thereby adjusting said third direction.

### CROSS-REFERENCE TO RELATED APPLICATIONS

This Application is the National Stage of International Application Ser. No. PCT/IL2015/050627, filed Jun. 21, 2015, which claims priority to Israeli Patent Application Ser. No. 233847, filed Jul. 29, 2014.

### BACKGROUND

Fluid supply conduits are known in the art and are vastly used for example for the purpose of fire suppression. Elevating and maneuvering supply conduits, such as fire hoses can be carried out in variety of methods.

U.S. Pat. No. 3,422,729 discloses two, generally fore and aft extending, hydraulic hoist cylinders individually universally mounted on a vehicle, said cylinders having hydraulic hoses converging therefrom to a juncture point between the cylinders and adjacent a support.

U.S. Pat. No. 2,984,422 discloses a fire hose nozzle comprising: a tubular inner section having front and rear ends with means at its rear end for connecting the same to a hose; a tubular intermediate section threaded onto and encircling the inner section; a tubular outer section having a first bore in which the front end portion of the inner section is slid-ably telescoped and a second larger bore rearwardly of the first bore and in which the front end portion of the intermediate section is slidably telescoped, so that the outer section is axially adjustable with respect to the inner section by moving in unison with the intermediate section as that section moves endwise as a result of relative, rotation between it and the inner section, and also by being moved endwise with respect to the intermediate section; cooperating flow Controlling means on the front ends of the inner and outer sections operable by relative axial adjustment of said inner and outer sections to control the pattern of the stream issuing from the nozzle; manually operable means for effecting relative rotation between the inner and intermediate sections; and power means for effecting relative axial motion between the intermediate and outer sections from a point remote from the nozzle.

It is noted that elevation and maneuvering of objects, such as people can be carried out in variety of ways, such as by using fluid jet. U.S. Pat. No. 7,614,355 discloses a personal flying water jet apparatus consisting of two towing connected units: one is a floating platform, mainly an inflatable Ski Tube, equipped with water jet nozzles directed downward and mounted on both sides by means of brackets; the other is an inlet port fixed on a tow line and connected with nozzles by mean of a hose. While the tube is being towed, the kinetic head appears and pressurized water is discharged at the nozzles producing a thrust, so the rider will fly.

U.S. Pat. No. 8,608,104 discloses a propulsion device comprising a body arranged for receiving a passenger and engaging with a thrust unit supplied with a pressurized fluid from a compression station. The arrangement of such a device offers great freedom of movement through the air or under the surface of a fluid.

### SUMMARY

There is provided according to one aspect of the presently disclose subject matter a fluid supply system comprising a conduit for supplying pressurized fluid therethrough and having a proximal end configured for being connected to a fluid source and a distal end with a supply outlet for dispensing the fluid in a first direction; the conduit further comprising at least one jet outlet configured for providing a jet fluid flow in a second direction other than the first direction, exerting thereby thrust on at least a portion of the conduit in a third direction; and a tilting mechanism configured for tilting the at least one jet outlet thereby adjusting the third direction.

The fluid can be configured for fire suppression and the fluid source can be a water tank, or a fire hydrant.

The supply outlet and the at least one jet outlet can be defined in a dispensing body.

The supply outlet hose reel nozzle can be configured to direct the fluid towards a fire source.

The second direction can be direction towards the ground, and the thrust can be configured to overcome gravitational forces exerted on said distal end of the conduit.

The dispensing body can include rectangular piping structure. The piping structure can include a plurality of jet outlets each defined at one corner thereof, and wherein the piping structure can be configured to allow fluid communication between the conduit and each of the jet outlets. The jet outlet can be configured to provide a downwardly jet flow exerting thereby on the dispensing body an upwardly thrust.

The direction of the thrust exerted by the jet outlets can be opposite to the direction of the sum of the vectors of the jet flows emitted therefrom.

The dispensing body can include a piping structure configured with a plurality of jet outlets each being in fluid communication with a pipe segment, such that the pipe segments perpendicularly extends with respect to one another, and wherein the supply outlet vertically extends from the center of the piping structure. Each of the jet outlets can be a U-Shaped outlet configured to provide a downwardly flow jet about one side of the supply outlet.

The tilting mechanism can be configured to tilt, yaw and/or roll the supply outlet. The tilting mechanism can include at least one auxiliary jet defined on the piping structure. The auxiliary jet can be configured to provide a downwardly fluid jet, being smaller respect to the jet provided by the jet outlet. The auxiliary jet can include two auxiliary jets each configured on one side of the piping structure and configured with a controllable jet such that the thrust exerted on one side of the piping structure can be different than that which can be exerted on the other side thereof.

The jet outlet can include a main port configured to provide a main flow jet, and wherein the auxiliary jet can be emitted from an auxiliary port configured to provide a controlled minor flow jet. The auxiliary port can include a valve.

The tilting mechanism can further include at least one horizontal jet configured to provide a horizontal jet flow with respect to the conduit. The horizontal jet can exert horizontal thrust on the dispensing body allowing thereby maneuvering thereof.

The dispensing body can be configured to rotate about a swivel pipe fitting with respect the conduit. The swivel pipe fitting joint can include an inlet port having a depression defined on the inner surface thereof, and a shoulder portion delimiting the opening of the depression, a ring having a flange portion configured to be disposed inside the depression such that the shoulder portion secures the flange portion inside the depression. The flange portion can be freely moves inside the depression.

The tilting mechanism can include directional adjustable nozzles mounted on the at least one jet outlet allowing thereby thrust vectoring of the jet coming out therefrom.

The fluid supply system can further comprise a pressure generator configured to allow adjusting the pressure inside the conduit thereby controlling the thrust exerted by the jet outlets. The conduit can include a plurality of channels each being in fluid communication with one of the jet outlets coupled to the distal end thereof and wherein the fluid pressure in each of the channels can be independently controlled by the pressure generator.

The jet outlet can include a valve configured to control the jet emitted therefrom.

The tilting mechanism can include at least one weight movably mounted on a X-Y moving mechanism extending along the dispensing body such that the disposition of the weight with respect thereto determines the tilting of thereof. The X-Y moving mechanism can include a first rod extending along an X axis, and having a plate mounted thereon such that the plate can be displaced along the length of the first rod. The X-Y moving mechanism can further include a second rod mounted on the plate along a Y axis, and having a weight mounted thereon such that the weight can be displaced along the length of the second rod. The plate can be automatically moved along the length of the first rod and the weight can be automatically moved along the length of the second rod by means of a step motor coupled to a pinion configured to engage a toothed rack.

The at least one jet outlet can include two pairs of jet outlets and wherein the tilting mechanism can be a mechanical arrangement having two weights each being movably mounted on a bar extending along the dispensing body.

The piping structure can be a cross shaped piping structure having a central jet outlet and wherein the tilting mechanism includes a plurality of side jets.

The jet outlet can be configured with a rotatable joint such that the direction of the flow jet emitted therefrom can be adjusted. The rotatable joint can be rotatable by a motor coupled thereto.

The jet outlet can include a first jet outlet and a second jet outlet and wherein the rotation of the rotatable joint of the first jet outlet can be independent from the rotation of the rotatable joint of the second jet outlet. The fluid pressure at the supply outlet can be different than that at the jet outlets.

The pressure at the supply outlet can be configured in accordance with the dispensing requirements at the location to which the fluid can be supplied, and wherein the pressure at the jet outlets can be configured to provide the required thrust.

The dispensing body can be provided with glass breaker disposed such that when the dispensing body can be directed towards a window, the glass breaker engages the window and with the forces exerted by the jet outlets the glass of the window can be cracked.

The dispensing body can be further provided with an inflatable member configured to be automatically inflated with fluid. The inflatable member can be mounted inside a compartment defined in the dispensing body. The compartment includes a cover pivotally mounted on the dispensing body, the cover being configured to be disposed over the compartment, such that when the inflatable member can be in a folded position thereof, it can be fully contained inside the compartment and in an inflated position thereof it extends out of the compartment and pushes the cover to pivot away form the compartment. The cover in the open position thereof can be configured to facilitate in stabilizing the dispensing body.

The conduit can include an inner conduit such as runs electrical power line, air hose, and fire retardant hose. The inner conduit can be so disposed in the conduit such that the water passing therein conduit provide mechanical and/or thermal protection thereto.

The dispensing body can further include accessories such as cameras, fire blanket, microphone, and speaker which can be used to assist rescuing people trapped in a building on fire.

In addition, the dispensing body and/or the conduit can include hooks for holding objects, or for allowing people to hang thereto. According to another aspect of the presently disclosed subject matter there is provided a dispensing body comprising: an inlet configured to be coupled to conduit for supplying pressurized fluid thereto from a fluid source; a supply outlet for dispensing the fluid in a first direction; at least one jet outlet configured for providing a jet fluid flow in a second direction other than the first direction, exerting thereby thrust on the dispensing body in a third direction; and a tilting mechanism configured for tilting the at least one jet outlet thereby adjusting the third direction.

According to yet another aspect there is provided a fluid supply system comprising a conduit for supplying pressurized fluid therethrough and having a proximal end configured for being connected to a fluid source and a distal end with a tiltable supply outlet configured for dispensing the fluid in a first direction and for providing a jet fluid flow in a second direction other than the first direction, exerting thereby thrust on at least a portion of the conduit in a third direction; and a tilting mechanism configured for tilting the supply outlet thereby adjusting the third direction.

The fluid source can be a fire track. The conduit can be extends from a pulley configured to be mounted on a top of a building. The conduit can be an elongated conduit having a plurality of segments each being provided with a jet outlet, and an end segment provided with a supply outlet wherein each jet outlet can be configured to elevate the respective segment.

The conduit can be an elongated conduit having a plurality of segments each being provided with a jet outlet, and an end segment provided with a supply outlet wherein each jet outlet is configured to elevate the respective segment.

According to yet another aspect there is provided a method for delivering fluid to a remote location through a conduit, the method comprising supplying pressurized fluid into a proximal end of the conduit, forming a jet fluid flow of the fluid at the distal end of the conduit, said jet fluid flow being directed towards the ground end being configured for exerting thereby thrust on at least a portion of the conduit configured to overcome the gravitational forces exerted on said portion, such that said portion is elevated towards; and dispensing the fluid from the conduit in direction towards the remote location.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates an isometric view of a dispensing body of a fluid supply system according to an example of the presently disclosed subject matter;

FIG. 2 illustrates an isometric view of a fluid supply system having a dispensing body according to yet another example of the presently disclosed subject matter;

FIG. 3 illustrates a partially transparent view of a fluid supply system having a dispensing body according to another example of the presently disclosed subject matter;

FIG. 4 illustrates a sectional view of a fluid supply system having a dispensing body according to a further example of the presently disclosed subject matter;

FIG. 5 illustrates a sectional view of a fluid supply system having a dispensing body according to a further example of the presently disclosed subject matter;

FIG. 6A illustrates an isometric view of a dispensing body of a fluid supply conduit according to another example of the presently disclosed subject matter;

FIG. 6B illustrates an isometric view of a dispensing body of a fluid supply conduit according to another example of the presently disclosed subject matter;

FIG. 6C illustrates an isometric view of a dispensing body of a fluid supply conduit according to another example of the presently disclosed subject matter;

FIG. 6D illustrates an isometric view of a dispensing body of a fluid supply conduit according to another example of the presently disclosed subject matter;

FIG. 7A illustrates an isometric view of a fluid supply system having a dispensing body according to another example of the presently disclosed subject matter;

FIG. 7B illustrates a sectional view of the fluid supply system of FIG. 7A;

FIG. 8A is a side sectional view of a fluid supply system having an inflatable member according to an example of the presently disclosed subject matter, in the folded position thereof;

FIG. 8B is a side sectional view of the fluid supply system of FIG. 8A having an inflatable member in the inflated position thereof;

FIG. 9 illustrates an isometric view of a dispensing body according to yet another example of the presently disclosed subject matter;

FIG. 10 illustrates an isometric view of a fluid supply system being utilized in accordance with an example of the presently disclosed subject matter;

FIG. 11 illustrates an isometric view of a fluid supply system being utilized in accordance with another example of the presently disclosed subject matter;

FIG. 12 illustrates an isometric view of a fluid supply system being utilized in accordance with yet another example of the presently disclosed subject matter; and

FIG. 13 illustrates an isometric view of a fluid supply system being utilized in accordance with a further example of the presently disclosed subject matter.

### DETAILED DESCRIPTION OF EMBODIMENTS

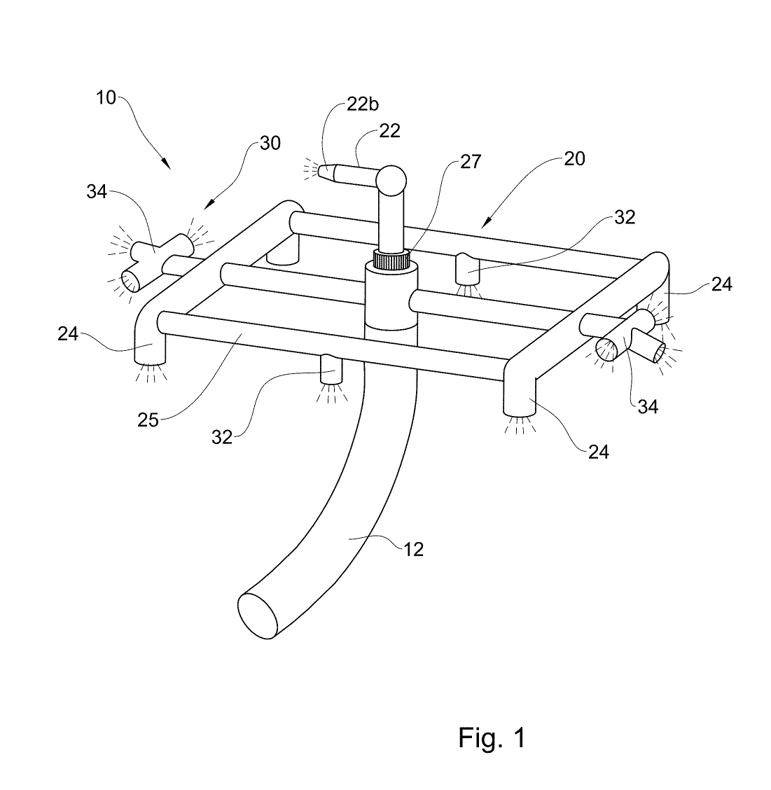

FIG. 1 shows a supply system 10 comprising a conduit 12 for supplying pressurized fluid therethrough and having a proximal end (not shown) configured for being connected to a fluid source. The fluid can be water for fire suppression, and the fluid source can be a water tank, or a fire hydrant configured to provide pressurized water.

The conduit 12 includes a distal end having a dispensing body 20 defining a supply outlet 22 configured for dispensing fluid in a first direction. The supply outlet 22 can be for example a hose reel nozzle, configured to direct water, or other suppression fluid, towards a fire source. The dispensing body 20 further includes a plurality of jet outlets 24 configured for providing a jet fluid flow in a second direction exerting thereby thrust on at least a portion of the conduit 12 in a third direction.

The second direction, i.e. the direction of the jet flow, can be direction towards the ground, and the thrust can be configured to overcome gravitational forces exerted on said distal end of the conduit.

According to the illustrated example the dispensing body 20 further includes rectangular piping structure 25, having four jet outlets 24 each defined at one corner thereof. The piping structure 25 allows fluid communication between the conduit 12 and the jet outlets 24. The jet outlets are configured to provide a downwardly jet flow exerting thereby on the dispensing body 20 an upwardly thrust.

It is appreciated that the direction of the thrust is typically opposite to the direction of the jet flow, however in case the jet outlets 24 are not all directed to the same direction, the direction of the thrust exerted thereby is opposite to the direction of the sum of the vectors of the jet flows.

The supply system 10 further includes a tilting mechanism 30 configured for tilt, yaw and/or roll the jet outlets 24 thereby adjusting the direction of the thrust exerted thereby. The tilting mechanism 30 according to the illustrated example includes two auxiliary jets 32 defined on the piping structure 25, for example between the jet outlets 24. The auxiliary jets 32, are configured to provide a downwardly fluid jet, which can be rather small jet with respect to the jet provided by the jet outlets 24.

According to an example the fluid jet provided by the auxiliary jets 32 can be controlled, such that the auxiliary jet 32 on one side of the piping structure 25 can be set to provide larger jet than that which is provided by the auxiliary jet 32 on the other side thereof. This way, the thrust exerted on one side of the piping structure 25 is slightly larger than that which is exerted on the other side thereof, resulting in a tilt of the dispensing body 20.

The tilting mechanism 30 can further include one or more horizontal jets 34 configured to provide a horizontal jet flow with respect to the piping structure 25. The horizontal jet can be utilized to exert horizontal thrust on the dispensing body 20 so as to allow maneuvering thereof.

It is appreciated that the fluid pressure at the supply outlet 22 can be different than that at the jet outlets 24. That is to say, the pressure at the supply outlet 22 can be configured in accordance with the dispensing requirements at the location to which the fluid is supplied, while the pressure at the jet outlets 24 is configured to provide the required thrust. For example, in the case of supplying water for fire suppression, the pressure at the supply outlet 22 is such which allows a sufficient water flow for extinguishing the fire, while the pressure at the jet outlets 24 is such which allows elevating and maneuvering the dispensing body towards the fire location. It is further noted that the thrust at the jet outlets can be configured to serve as a counterforce to the thrust exerted by the water flow dispensed from supply outlet 22.

As known in the art, the supply outlet 22 can be provided with an adjustable reel nozzle 22b, so that the fluid can be directed towards the desired location, such as the source of the fire. The supply outlet 22 can be configured with a remote controller, such which allows controlling the operation thereof, and adjusting the orientation of the adjustable reel nozzle 22b remotely.

According to an example the supply outlet 22 can be provided with a motor 27 for rotating the reel nozzle 22b about the axis thereof such that the nozzle can be rotated and directed to the desired location. The motor 27 can be configured for remote controlling thereof.

The supply system 10 allows providing fluid to a remote location by maneuvering the dispensing body 20 by utilizing the fluid jet. The dispensing body 20 can, thus, be elevated and can be further tilted and directed towards the fire source.

It is appreciated that the jet outlets 24 can also be equipped with directional adjustable nozzles or water jet deflectors to allow thrust vectoring to be used to direct the jet coming out from the jet outlets in different direction. The directional adjustable nozzles or water jet deflectors can be utilized for horizontal movement and for directing the outlet jet to a fire source without the use of a dedicate supply outlet. This way, the jet outlet can serve as a dual outlet instead of having a jet outlet and a supply outlet.

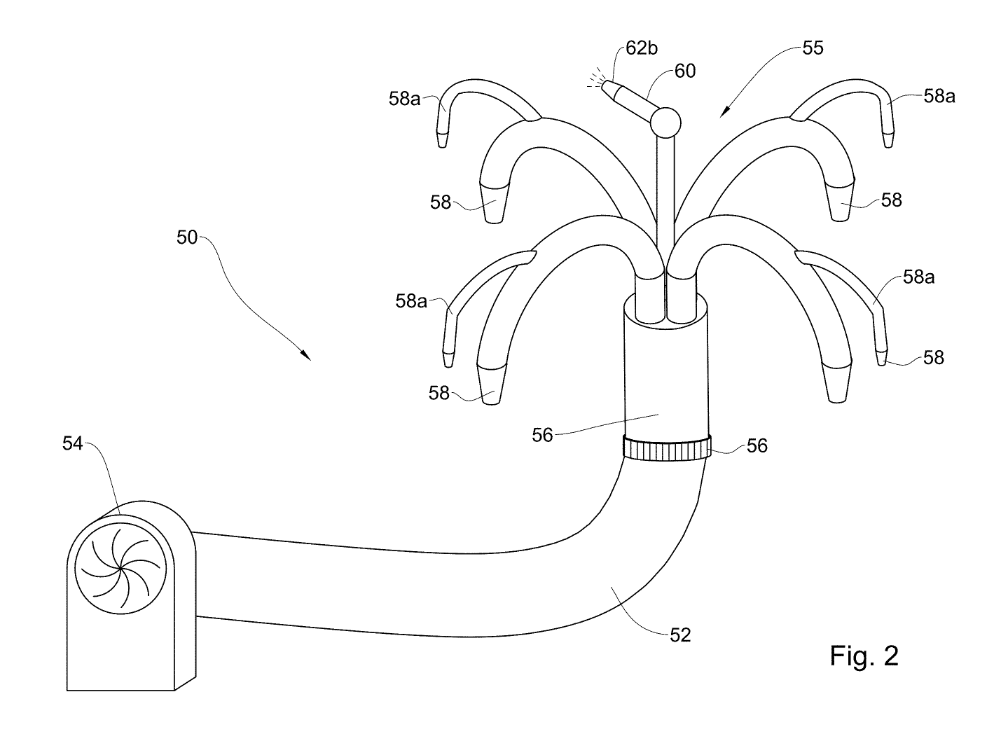

Reference is now made to FIG. 2, according to an example the supply system 50 can include a conduit 52 having a proximal end coupled to a water source (not shown). In order to provide the water inside the conduit 52 with the required pressure, such which can exert an uplifting thrust, a pressure generator 54 can be coupled to the conduit 52.

The conduit 52 on the distal end thereof is coupled to a rotatable dispensing body 55 configured to rotate about a swivel pipe fitting 56, and having one or more jet outlets 58, (here illustrated as four) and a supply outlet 60 at the center of the jet outlets. Each of the jet outlets 58 is configured as a U-Shaped outlet configured to provide a downwardly flow jet about one side of the supply outlet 60 such it is provided with an upwardly thrust exerted by the four downwardly flow jets. Each of the jet outlets 58 is provided with an auxiliary jet 58a configured to provide a small jet with respect to the jet provided by the jet outlets 58. The direction and magnitude of the jet from the auxiliary jet 58a allowing thereby to controls the tilting of the dispensing body 55. The supply outlet 60 can be provided with an adjustable reel nozzle 62b which according to an example is controlled remotely.

The pressure generator 54 can be configured to allow adjusting the pressure inside the conduit 52, thereby controlling the thrust exerted by the jet outlets 58 and consequently the movement of the dispensing body 55.

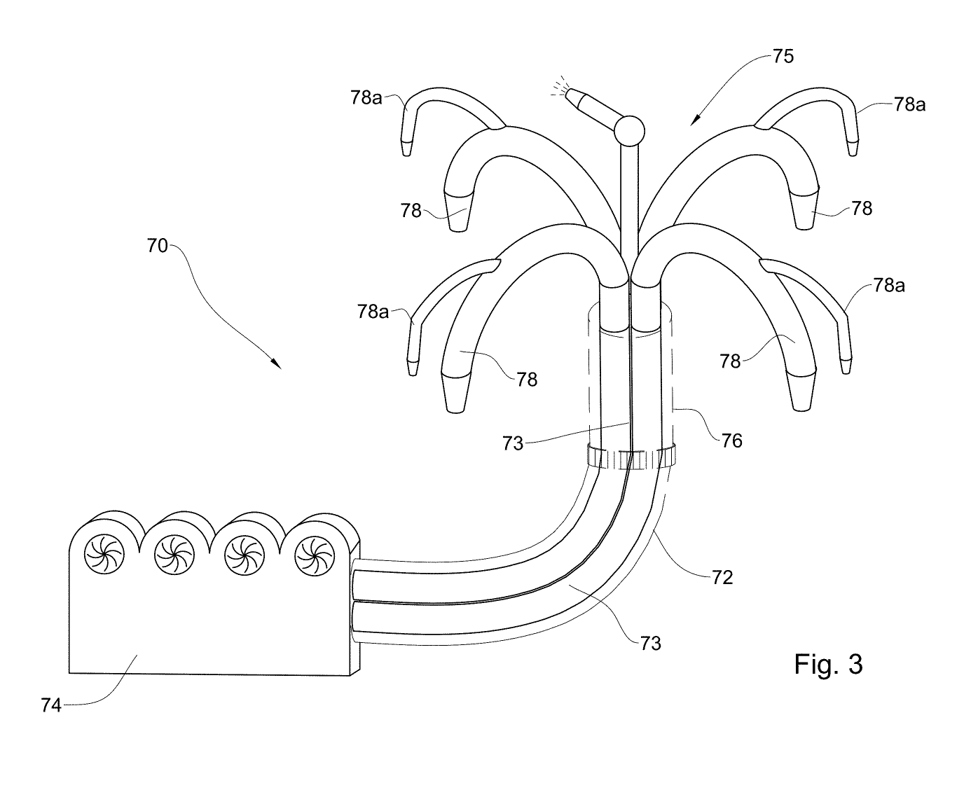

As shown in FIG. 3, the supply system 70 can include a conduit 72 having a rotatable dispensing body 75 mounted on one end thereof, substantially the same as the dispensing body 55 of FIG. 3A, being provided with a swivel pipe fitting 76, and having four U-shaped jet outlets 78, auxiliary jet 78a, and a supply outlet 80 at the center of the jet outlets. According to the present example the conduit 72 includes four channels 73 each being in fluid communication with one of the U-shaped jet outlet 78 coupled to the distal end thereof and a dedicated pressure generator 74. The pressure generators 74 of each jet outlet 78 allows con adjusting the pressure inside the respective channel 73, thereby controlling the thrust exerted by the respective jet outlets 78.

This way, the thrust of each jet outlet 78 can be independently controlled such that if the thrust provided by one of the jet outlet 78 is larger than that which is provided by the other jet outlet 78, the dispensing body 75 is tilted towards the jet outlet 78 having a weaker pressured fluid flow. The separated supply outlet channel is not shown.

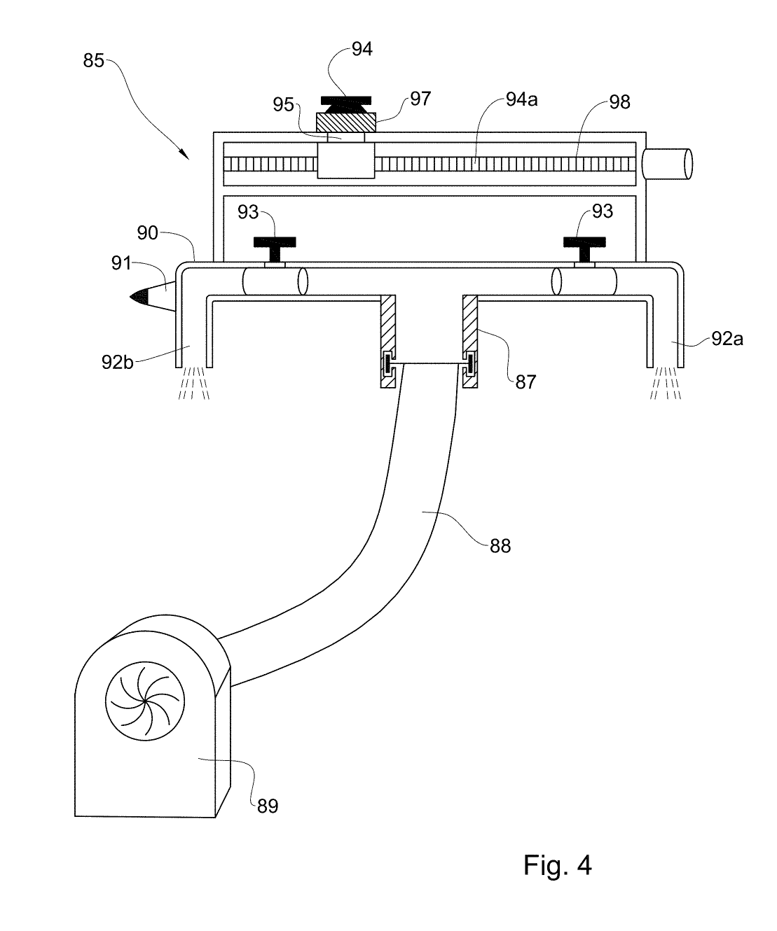

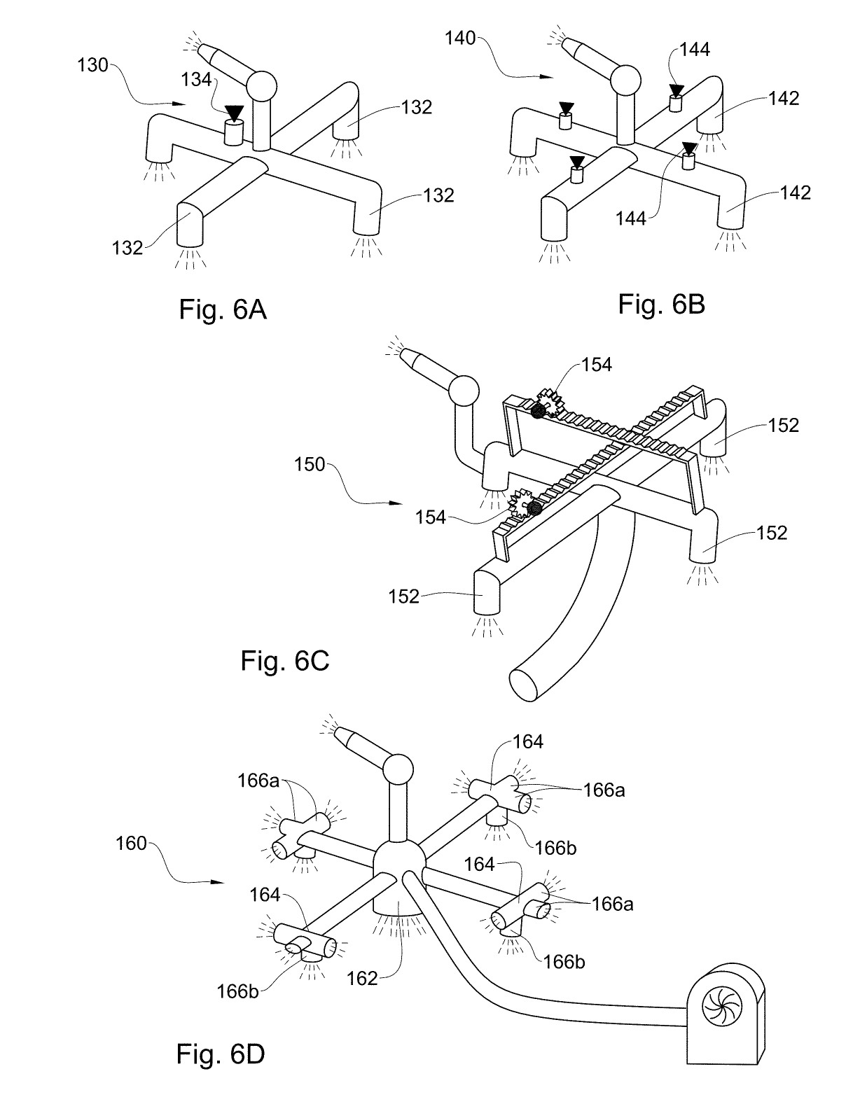

FIG. 4 shows a dispensing body 85 according to a further example, being coupled to a conduit 88 which can be provided with a pressure generator 89. The dispensing body 85 can be provided with an inlet port 87 being in fluid communication with a first and a second jet outlet 92a and 92b through piping structure 90. The fluid flow in each of the jet outlets 92a and 92b can be controlled by a valve 93, such that the thrust provided by one of the jet outlets 92a or 92b can be greater than that which is provided by the other jet outlet. This way, in case for example the flow through the first jet outlet 92a is greater than that through the second jet outlets 92b the dispensing body tilts towards the second jet outlets 92b. It is appreciated that the dispensing body 85 can include three or more jet outlets for example defined around the inlet port 87 for example as shown in FIG. 6C.

In addition, the dispensing body 85 can be provided with a tilting mechanism 95 having a weight 97 movably mounted on a rod 98 extending between the first jet outlet 92a and the second jet outlet 92b. The disposition of the weight 97 with respect to the jet outlets 92a and 92b determines the tilting of the dispensing body 85. According to an example the weight 97 can be automatically moved along the length of the rod 98, by means of a step motor 94 coupled to a pinion (not shown) configured to engage a toothed rack 94a. This way, the motor 94 is activate to rotate the pinion in one direction, the teeth of the pinion engage the corresponding teeth on the rack 94a, causing the movement thereof along the rack 94a. It is appreciated that other mechanisms can be used for moving the weight 97 along the rod 98, and can be configured for controlling thereof remotely.

According to an example the tilting mechanism can include at least one weight movably mounted on a X-Y moving mechanism extending along the dispensing body such that the disposition of the weight with respect thereto determines the tilting of thereof. The X-Y moving mechanism can include a first rod extending along an X axis, and having a plate mounted thereon such that the plate can be displaced along the length of the first rod. The X-Y moving mechanism can further include a second rod mounted on the plate along a Y axis, and having a weight mounted thereon such that the weight can be displaced along the length of the second rod. The plate can be automatically moved along the length of the first rod and the weight can be automatically moved along the length of the second rod by means of a step motor coupled to a pinion configured to engage a toothed rack.

The dispensing body 85 can be further provided with glass breaker 91 disposed such that when the dispensing body 85 is directed towards a window, the glass breaker 91 engages the window and with the forces exerted by the jet outlets 92a and 92b the glass of the window can be cracked.

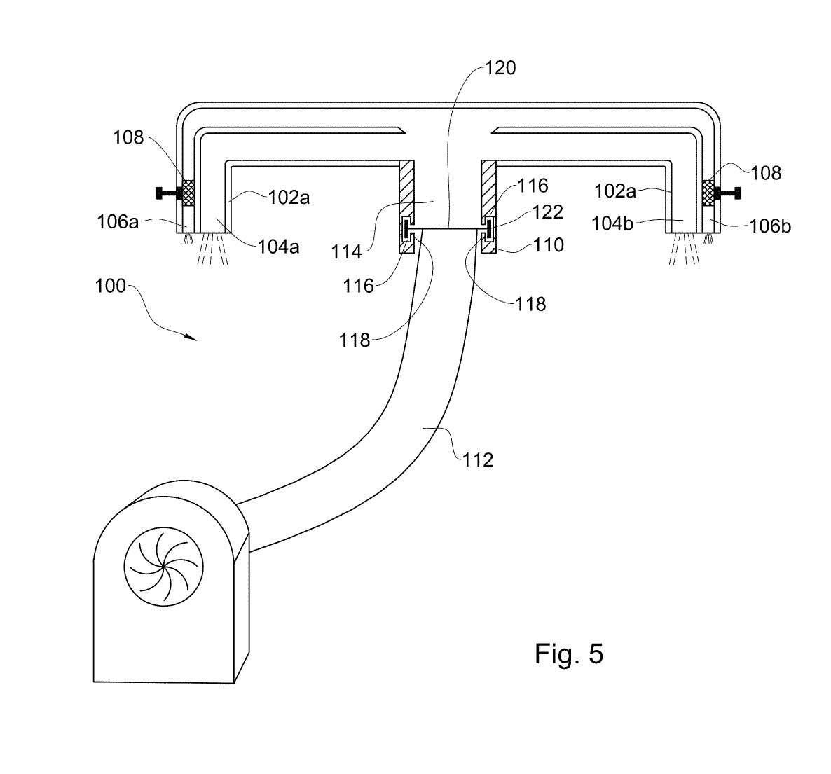

FIG. 5 shows yet a further example of the presently disclosed subject matter, according to which the dispensing body 100 includes a first and a second jet outlet 102a and 102b each having a main port 104a and 104b configured to provide a main flow jet, and an auxiliary port 106a and 106b configured to provide a controlled minor flow jet. The auxiliary ports 106a and 106b are formed with a valve 108 for controlling the fluid flow therethrough. According to this example while the main ports 104a and 104b of jet outlets 102a and 102b provide a substantially equal downwardly jet, exerting thereby an even upward thrust, each of the auxiliary port 106a and 106b can provide a controlled flow jet. That is to say, the valve 108 of the auxiliary port 106a of the first jet outlet 102a can be set to allow flow which is smaller than that which flows through the auxiliary port 106a of the second jet outlet 102b. This way, the upward thrust exerted on the dispensing body 100 is not symmetric resulting in a tilt thereof towards the firs jet outlet 102a.

According to an example the dispensing body 100 can be provided with a swivel joint 110 for coupling thereof to a conduit 112. The swivel joint 110 can include an inlet port 114 having a depression 116 defined on the inner surface thereof, and a shoulder portion 118 delimiting the opening of the depression 116. The swivel joint 110 further includes a ring 120 defining a inner portion through which fluid can flow, and a flange portion 122 configured to be disposed inside the depression 116 at the inlet port 114. The shoulder portion 118 is configured to secure the flange portion 122 inside the depression 116. In order to allow rotation of the dispensing body 100 about the axis of the conduit 112, the flange portion 122 is adapted such that it can freely move inside the depression 116. It is appreciated that the swivel joint 110 is configured such that water flowing therethrough does not escape

Reference is now made to FIGS. 6A to 6D, the dispensing body according to other examples can be provided with a cross shape piping structure however having various tilting mechanisms. In FIG. 6A, for example the dispensing body 130 includes a piping structure having four jet outlets 132 and being provided with a main valve 134 configured to control the flow rate in each of the jet outlets 132, thereby controlling the thrust exerted therefrom.

FIG. 6B shows a dispensing body 140 having a piping structure similar to that of FIG. 6A and including four jet outlets 142. According to this example each jet outlets 142 is configured with a valve 144 configured to control the flow rate therein, thereby controlling the thrust exerted thereby.

FIG. 6C shows a dispensing body 150 having a cross shape piping structure similar to that of FIG. 6B and including four jet outlets 152. According to this example the tilting mechanism is a mechanical arrangement having two weights 154 each being movably mounted on a bar extending between a pair of jet outlets 152. The disposition of weights 154 with respect to the jet outlets 152 determines the tilting of the dispensing body 150.

Further example is shown in FIG. 6D, the dispensing body 160 having a cross shape piping structure similar to that of FIG. 6B can include a central jet outlet 162 and a tilting mechanism in a form of a plurality of side jets 164. While the central jet outlet 162 is configured to provide a downwardly jet thereby exerting an upwardly thrust, the side jets 164 can provide a controlled jet thereby allowing controlling the tilting of the dispensing body 160. The side jets 164 can include horizontal jet 166a exerting a sideward thrust as well as downwardly jet 166b exerting a minor upward thrust. It is appreciated that the jet provided by each of the side jets 164 can be independently controlled, thus, the direction of the thrust exerted thereby can be controlled. Controlling the jet of each of the side jets 164 can be carried out by means of a valve.

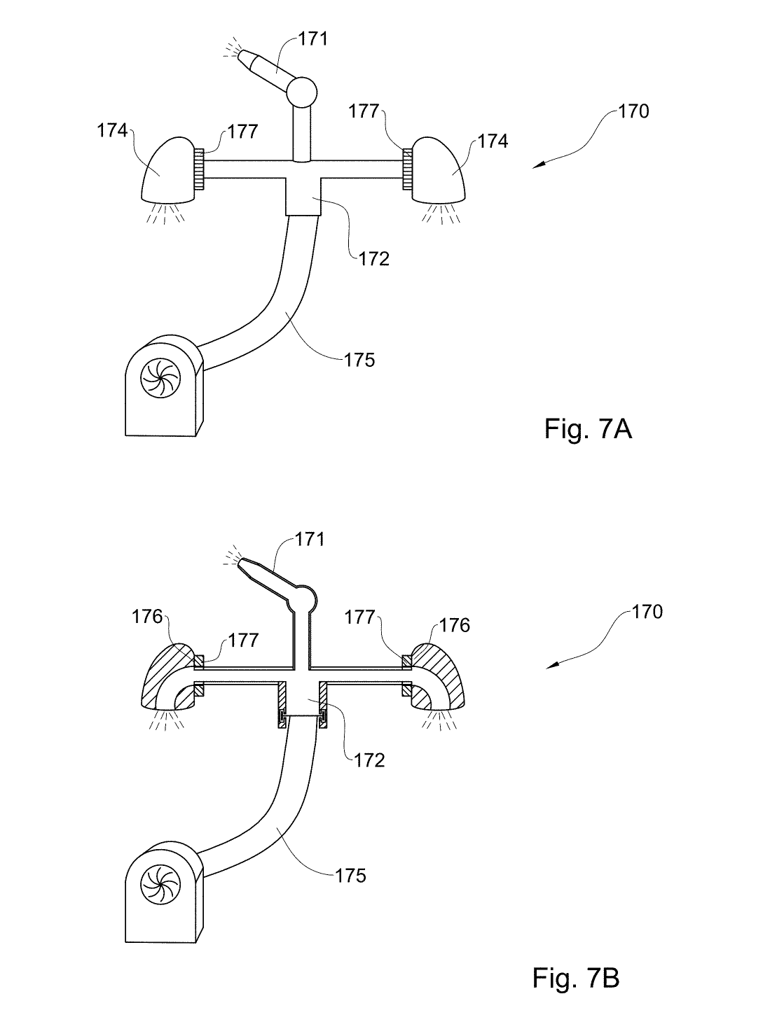

FIGS. 7A and 7B illustrate a further example of a dispensing body 170 having a pipe structure defining an inlet 172, to which a supply conduit 175 is coupled, and two jet outlets 174. The jet outlets 174 according to this example are configured with a rotatable joint 176, such that the direction of the flow jet emitted therefrom can be adjusted. The weight of the water inside the supply conduit 175 provide the dispensing body 170 with a low center of gravity and serves as balancing means for the system.

According to an example the rotatable joint 176 is rotatable by a motor 177 coupled thereto, which can be remotely controlled. It is appreciated that the rotation of the rotatable joint 176 of one jet outlet 174 can be independent from the rotation of the rotatable joint 176 of the other jet outlet 174. For example, the rotatable joint 176 of one jet outlet 174 can be rotated such that the jet is directed downwardly, however slightly forward, while the rotatable joint 176 of the other jet outlet 174 can be rotated such that the jet therefrom is directed downwardly, however slightly backwards. This way, the dispensing body 170 can swivels in a yaw maneuver, and the supply outlet 171 can be directed to provide fluid, such as water, to the desired location.

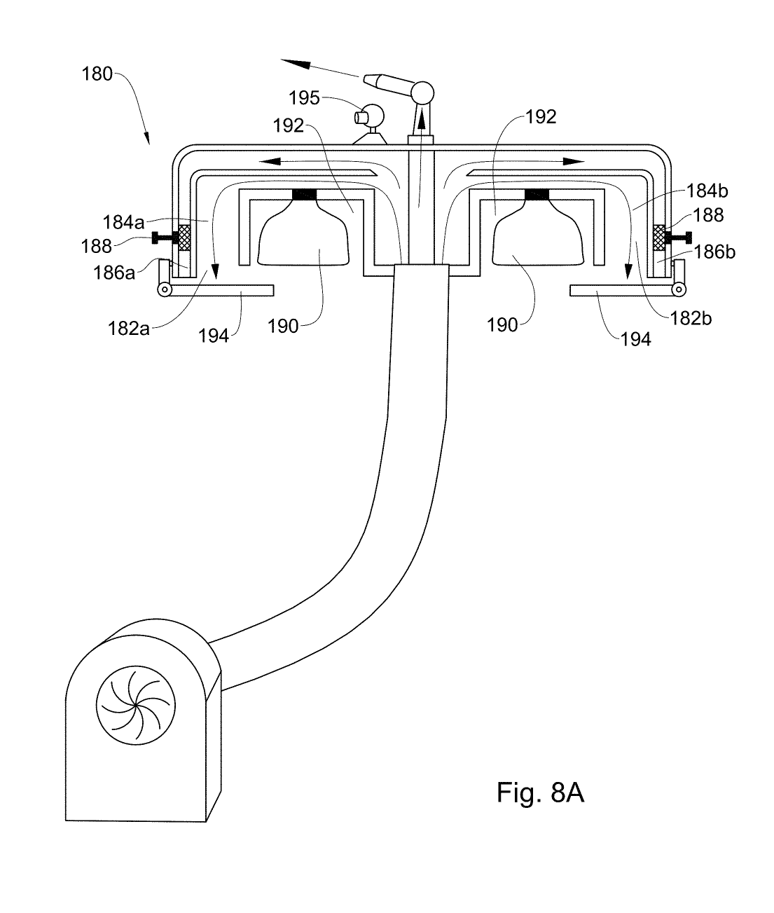

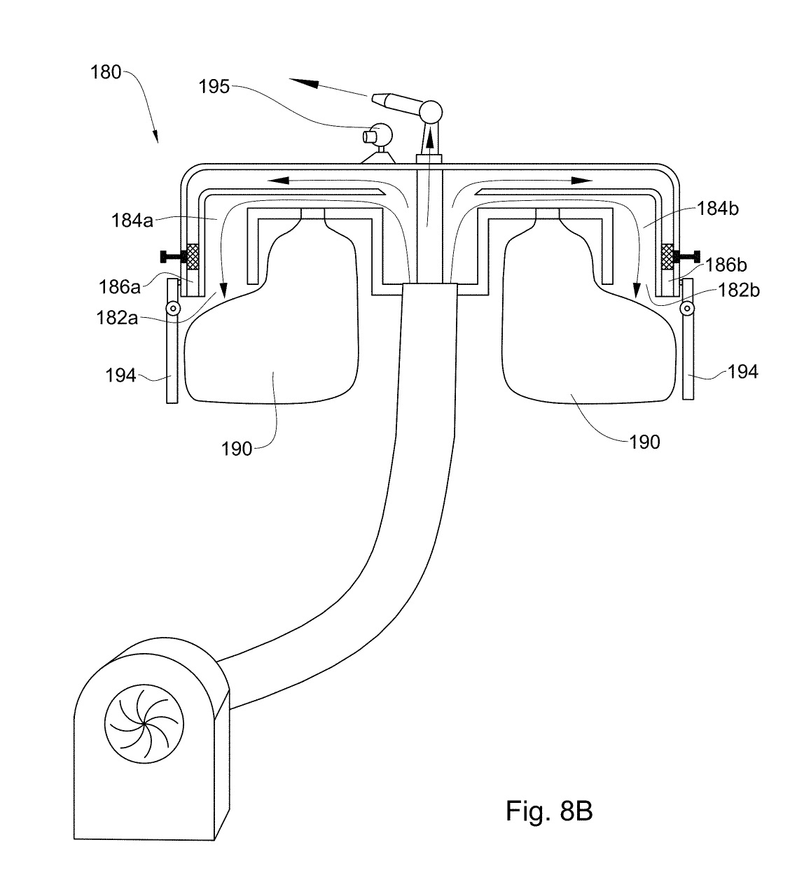

Reference is now made to FIGS. 8A and 8B, the dispensing body 180 can include a first and a second jet outlet 182a and 182b each having a main port 184a and 184b configured to provide a main flow jet, and an auxiliary port 186a and 186b configured to provide a controlled minor flow jet. Each of the auxiliary ports 186a and 186b are formed with a valve 188 for controlling the fluid flow therethrough. According to this example while the main ports 184a and 184b of jet outlets 182a and 182b provide a substantially equal downwardly jet, exerting thereby an even upward thrust, each of the auxiliary port 186a and 186b can provide a controlled flow jet. That is to say, the valve 188 of the auxiliary port 186a of the first jet outlet 182a can be set to allow flow which is smaller than that which flows through the auxiliary port 186a of the second jet outlet 182b. This way, the upward thrust exerted on the dispensing body 180 is not symmetric resulting in a tilt thereof towards the first jet outlet 182a. It is appreciated that the dispensing body 180 can, include further jet outlets perpendicularly disposed with respect to first and second jet outlet 182a and 182b.

According to an example the dispensing body 180 can be provided with an inflatable member 190 configured to be automatically inflated with fluid, such as water and can be utilized for example as a grip portion of the dispensing body 180. The inflatable member 190 can be mounted inside a compartment 192 defined in the dispensing body 180. According to the illustrated example the inflatable member 190 includes two members each being mounted inside a compartment defined adjacent one of the jet outlets 182a and 182b. Each one of the compartments 192 can be covered by a cover 194, which according to one example, is pivotally mounted on the dispensing body 180. The cover 194 is configured to be disposed over the compartment 192, such that when the inflatable member 190 is in the folded position thereof, it is fully contained inside the compartment 192 and the cover 194 provides protection thereto. However, when the inflatable member 190 is in the inflated position thereof, as shown in FIG. 8B, it extends out of the compartment 192 and pushes the cover 194 to pivot away from the compartment 192. The cover 194 according to an example can be one or more rods disposed at the opening of the compartment 192 such that the water jets emitted out of the jet outlets 182a and 182b are not interrupted thereby. It is appreciated that the cover 194 in the open position thereof can be configured to facilitate in stabilizing the dispensing body 180, for example when the dispensing body has reached the desired location

The inflatable member 190 can be used to secure the position of the dispensing body 180. For example, the dispensing body 180 can be elevated outside a building by the forces exerted by the jet outlets 182a and 182b until the dispensing body 180 reaches the desired floor. The dispensing body 180 can be further directed to an opening in the building, such as a window, by utilizing the auxiliary ports 186a and 186b to tilt and maneuver the dispensing body 180, and can be further directed through the window. Once the dispensing body 180 is inside the building the inflatable member 190 can be inflated such that the volume thereof exceeds at least on dimension of the window, thereby serving as a stop member and precluding the dispensing body 180 from falling out of the window. At this position the jet outlets 182a and 182b can be deactivated.

According to another example, the dispensing body 180 can be lowered to the floor and the inflatable member can be filled with water such that weight added thereto maintain the dispensing body 180 on the floor. In addition, the cover can be utilized to provide the dispensing body 180 with further stability such that the supply outlet can deliver water towards the fire source without an unwanted tilting of the dispensing body

It will be appreciated that the inflatable member 190 can be remotely activated to shift between the folded position thereof and the inflated position thereof, and can be further automatically activated, and be filled with fluid from the conduit.

According to an example the dispensing body 180 can be provided with a sensor 195, such as a camera, allowing a remote control of thereof. The sensor 195 can be used for transferring a visual image to a remote operator, which can control the operation of the jet outlets 182a and 182b and can direct the dispensing body 180 to the desired location by utilizing the auxiliary ports 186a and 186b. The sensor 195 can further be configured to detect the desired location to which the fluid from the dispensing body 180 is to be directed. For example, the sensor 195 can be configured to detect fire and to automatically direct water thereto, or direct the dispensing body 180 to maneuver towards the source of the fire.

The dispensing body can further include accessories such as cameras, fire blanket, microphone, and speaker which can be used to assist rescuing people trapped in a building on fire.

The conduit can include an inner conduit such as runs electrical power line, air hose, and fire retardant hose. The inner conduit can be so disposed in the conduit such that the water passing therein conduit provide mechanical and/or thermal protection thereto.

It is appreciated that the dispensing body 180 can also include an autonomous control system that can control all aspects of the dispensing body operation. In addition, instead of or in addition to the supply outlet, the conduit can include holes provided with valves that can be controlled to open and close and deliver water to the surroundings.

The dispensing body 180 can also include additional accessories such as a first aid, survival kit, fire blanket a microphone and a speaker, etc, to allow communication and rescuing trapped people in the fire zone.

According to an example the dispensing body and the conduit can include hooks and gripping means configured to allow one or more persons to hang on them, such that the dispensing body can drag them away from the fire zone,

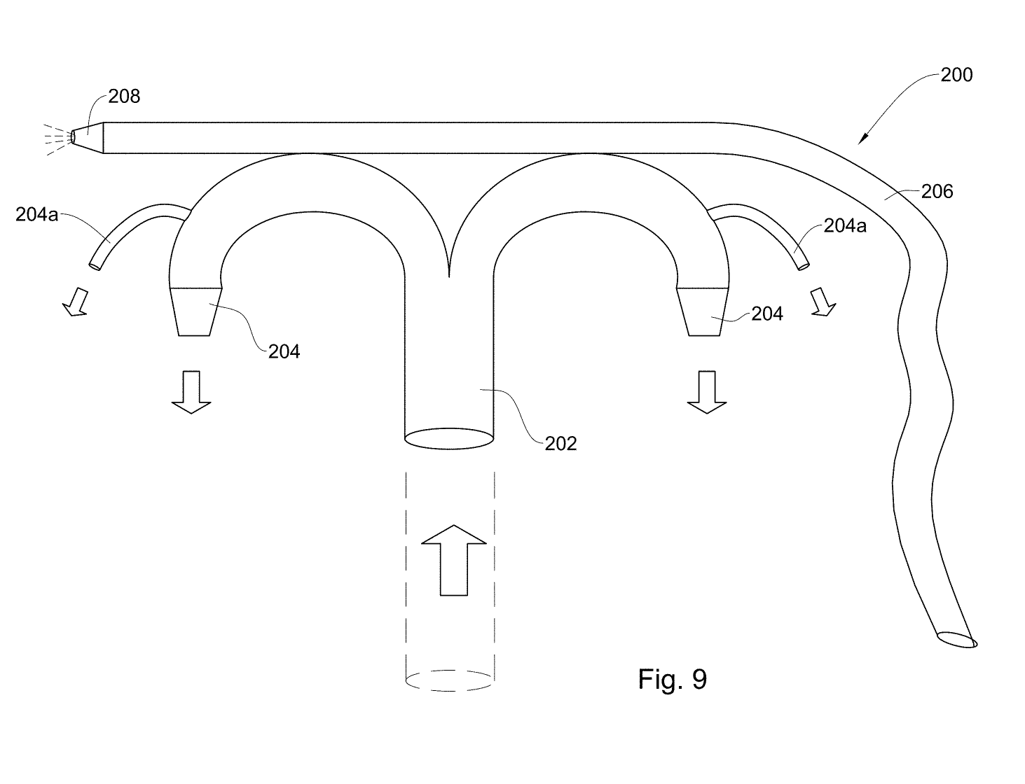

Attention is now made to FIG. 9, the fluid supply system 200 according to an example can include a first conduit 202 for providing pressurized fluid therethrough and having at least one jet outlet 204 configured for providing a jet fluid flow in a direction, for example downwardly, exerting thereby an upward thrust.

The fluid supply system 200 further includes a second conduit 206 having a supply outlet 208 for supplying fluid therethrough. The supply outlet 208 is coupled to the jet outlet 204, such that the thrust exerted by the fluid jet emitted from the jet out let 204, allows elevation of the supply outlet 208. As in the previous examples each of the jet outlets 204 can include an auxiliary jet 204a which can be utilized for tilting the supply outlet 208 to the desired direction.

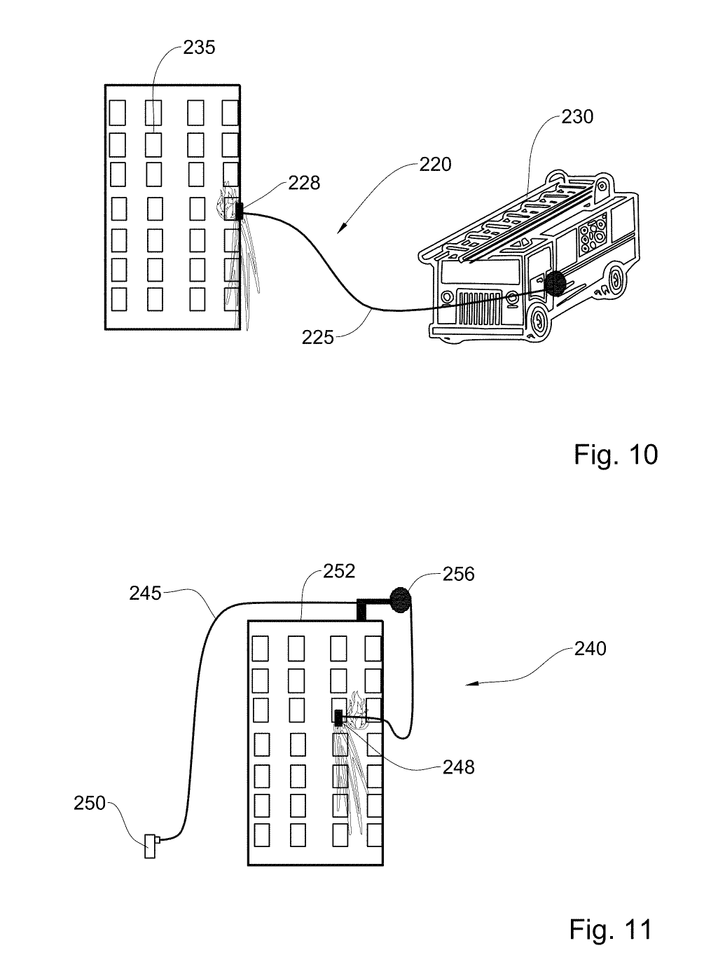

Attention is now directed to FIGS. 10 to 13, illustrating examples of implementations of the presently disclosed fluid supply system. For example, a fluid supply system 220 having a dispensing body 228 and a conduit 225 configured for supplying pressurized water, the proximal end thereof can coupled to a fire track 230. The dispensing body 228 having at least one jet outlet and a supply outlet can be utilized to elevate the distal end of the conduit 225 towards a fire source for example in a high floor of a building 235. The tilting mechanism of the dispensing body 228 can be utilized for tilting thereof until reaching the exact location of the fire, and can be further utilized for adjusting the direction in which the supply outlet provides water.

It is appreciated that the water emitted from the jet outlet can be used for extinguishing fire in other areas around the building 235, or to prevent the fire from extending outside the building.

According to another example, as shown in FIG. 11, a water supply system 240 having a dispensing body 248 and a conduit 245 can be coupled to a pressurized water source, such as a fire hydrant 250. The conduit 245 can extend to the top of a building 255, and can be mounted on a pulley 256 on the building roof 257, and can be further extended to the fire source at any floor of the building. The pulley 256 can be used to hold the conduit 245, the jet outlet of the dispensing body 248 can be used to further direct and maneuver the dispensing body 248 to the exact location. It is appreciated that maneuvering of the dispensing body 248 can be carried out by a tilting mechanism such as one ore more auxiliary jets defined thereon. It is appreciated that the use of the pulley 256 and extending the conduit 245 from the top of the building allows using a jet which is directed to move the dispensing body 248, while the elevation thereof is carried out by the pulley 256. In addition, the pulley bears the weight of the water filling the conduit.

It is further appreciated that the water supply system 240 can be configured to be coupled to a suppression system of the building, such that the water supply system 240 can be automatically activated once a fire has started.

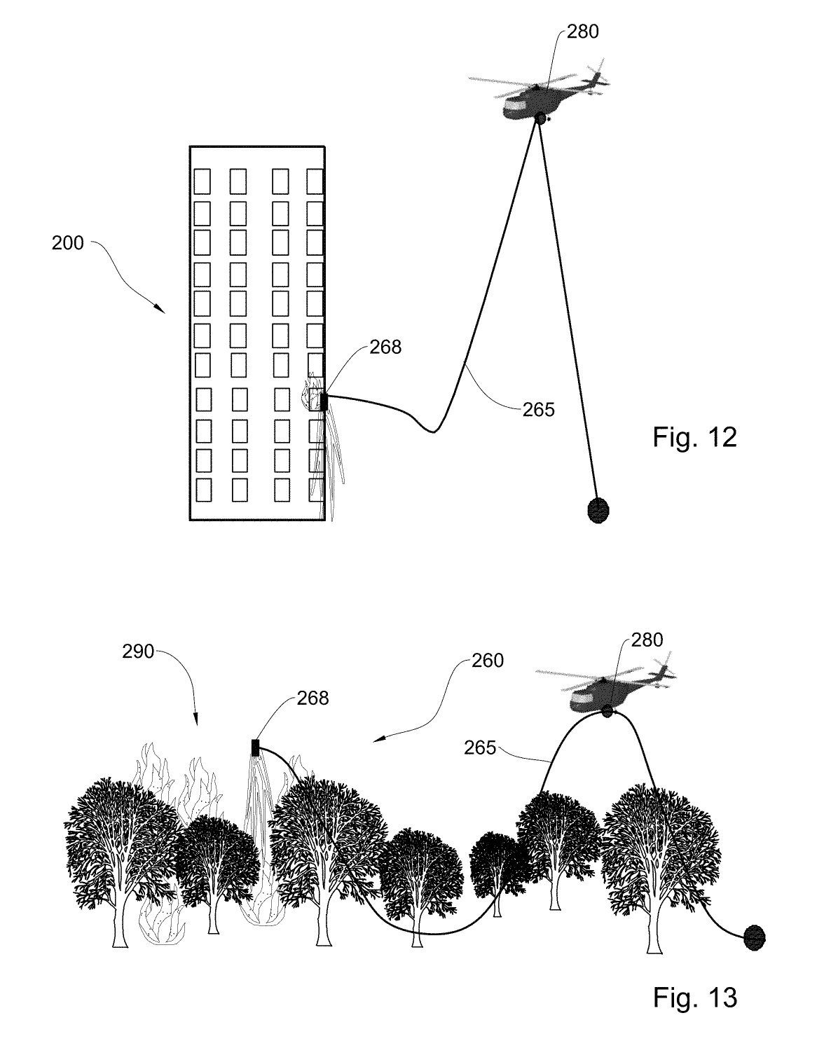

As similar example is shown in FIGS. 12 and 13, where a water supply system 260 includes a dispensing body 268 and a conduit 265 can be coupled to a pressurized water source, such as a fire hydrant 270. The conduit 265 according to this example is coupled to a helicopter 280 such that the jet outlet of the dispensing body 268 is configured to maneuver thereof, while the elevation of the conduit is carried out by the helicopter. In another embodiment the helicopter can carry a water tank such that the conduit does not have to be fluidly coupled to a land fire hydrant.

As shown in FIG. 13, the water supply system 260 can be used for extinguishing fire at a far location. The helicopter 280 in this example is utilized to bring the conduit closer to the fire source 290, while the dispensing body 268 is utilized to bring the conduit above the fire source 290. Thus, according to this example the jet outlet of the dispensing body 268 is configured to elevate thereof as well as to extinguish the fire.

According to a further example the jet outlet can be defined at any location along the conduit, rather than at the distal end thereof. Accordingly, the jet outlet can be defined such that the jet flow thereof can elevate a portion of the conduit. According to an example the conduit can be an elongated conduit having a plurality of segments each being provided with a jet outlet, while the end segment is further provided with a supply outlet. Each jet outlet can be configured to elevate the respective segment of the conduit such that the entire conduit can be elevated. According to an example, each jet outlet can be provided with a tilting mechanism which is configured to tilt the jet outlet or the segment on which it is mounted, such that the segment can be maneuvered. Accordingly, the conduit can be maneuver as a snake robot, that is to say, each segment can be elevated and moved forward by the jet outlet thereof, such that the entire conduit is moved forwards. According to an example the elongated segmented conduit can be used to bring the conduit forward until the supply outlet reaches the desired location.

It should be appreciated that all the wires for control, data and electricity can be passed inside the conduit. This way, the water flowing through the conduit prevents the wires from being heated by the high temperatures in the fire zone. According to a further example the conduit can include an outer conduit for allowing water flow therethrough and an inner conduit for passing therethrough fire retardant, air, and other materials.

Those skilled in the art to which the presently disclosed subject matter pertains will readily appreciate that numerous changes, variations, and modifications can be made without departing from the scope of the invention, mutatis mutandis.

What is claimed is:

1. A fluid supply system comprising a conduit for supplying pressurized fluid therethrough and having a proximal end configured for being connected to a fluid source and a distal end with a supply outlet for dispensing said fluid in a first direction; said conduit further comprising at least one jet outlet configured for providing a jet fluid flow in a second direction other than the first direction, exerting thereby thrust on at least a portion of said conduit in a third direction; and a tilting mechanism configured for tilting said at least one jet outlet thereby adjusting said third direction.

2. The fluid supply system according to claim 1 wherein said fluid is configured for fire suppression.

3. The fluid supply system according to claim 2 wherein the fluid source is a water tank, or a fire hydrant.

4. The fluid supply system according to claim 1 wherein said supply outlet and said at least one jet outlet are defined in a dispensing body.

5. The fluid supply system according to claim 1 wherein said supply outlet includes a hose reel nozzle configured to direct said fluid towards a fire source.

6. The fluid supply system according to claim 4 wherein said dispensing body includes a piping structure.

7. The fluid supply system according to claim 6 wherein said piping structure includes a plurality of jet outlets each defined at one corner thereof, and wherein said piping structure is configured to allow fluid communication between the conduit and each of said jet outlets.

8. The fluid supply system according to claim 7 wherein direction of the thrust exerted by said jet outlets is opposite to the direction of the sum of the vectors of the jet flows emitted therefrom.

9. The fluid supply system according to claim 1 wherein dispensing body includes a piping structure configured with a plurality of jet outlets each being in fluid communication with a pipe segment, such that the pipe segments perpendicularly extends with respect to said supply outlet, and wherein said supply outlet vertically extends from the center of the piping structure.

10. The fluid supply system according to claim 1 further comprising a pressure generator configured to allow adjusting the pressure inside the conduit thereby controlling the thrust exerted by the jet outlets.

11. The fluid supply system according to claim 10 wherein said conduit includes a plurality of channels each being in fluid communication with one of the jet outlets coupled to the distal end thereof and wherein the fluid pressure in each of said channels is independently controlled by said pressure generator.

12. The fluid supply system according to claim 1 wherein said tilting mechanism includes at least one weight movably mounted on a rod extending along the dispensing body such that the disposition of the weight with respect thereto determines the tilting of thereof.

13. The fluid supply system according to claim 1 wherein said jet outlet is configured with a rotatable joint such that the direction of the flow jet emitted therefrom can be adjusted.

14. The fluid supply system according to claim 13 wherein said jet outlet includes a first jet outlet and a second jet outlet and wherein the rotation of the rotatable joint of the first jet outlet is independent from the rotation of the rotatable joint of the second jet outlet.

15. The fluid supply system according claims 1 wherein the dispensing body is further provided with an inflatable member configured to be automatically inflated with fluid.

16. The fluid supply system according to claim 15 wherein the inflatable member is mounted inside a compartment defined in the dispensing body.

17. The fluid supply system according to claim 16 wherein the compartment includes a cover pivotally mounted on the dispensing body, said cover being configured to be disposed over the compartment, such that when the inflatable member is in a folded position thereof, it is fully contained inside the compartment and in an inflated position thereof it extends out of the compartment and pushes the cover to pivot away form the compartment.

18. A fluid supply system comprising a conduit for supplying pressurized fluid therethrough and having a proximal end configured for being connected to a fluid source and a distal end with a tiltable supply outlet configured for dispensing said fluid in a first direction and for providing a jet fluid flow in a second direction other than the first direction, exerting thereby thrust on at least a portion of said conduit in a third direction; and a tilting mechanism configured for tilting said supply outlet thereby adjusting said third direction.

19. The fluid supply system according to claim 18 wherein said fluid source is a fire track.

20. The fluid supply system according to claim 18 wherein said conduit is extends from a pulley configured to be mounted on a top of a building.

21. The fluid supply system according to claim 18 wherein said conduit is an elongated conduit having a plurality of segments each being provided with a jet outlet, and an end segment provided with a supply outlet wherein each jet outlet is configured to elevate the respective segment.

22. A method for delivering fluid to a remote location through a conduit, the method comprising:
supplying pressurized fluid into a proximal end of the conduit;
forming a jet fluid flow of the fluid at the distal end of the conduit, said jet fluid flow being directed towards the ground end being configured for exerting thereby thrust on at least a portion of the conduit configured to overcome the gravitational forces exerted on said portion, such that said portion is elevated towards; and
dispensing the fluid from the conduit in direction towards the remote location.
